(19) United States
(12) Patent Application Publication
(10) Pub. No.: US 2026/0251784 A1
(43) Pub. Date: Aug. 27, 2026

(54) A PEDESTRIAN MONITORING SYSTEM FOR A WAREHOUSE

(71) Applicant: THREE SMITH GROUP LIMITED, Elland, West Yorkshire (GB)

(72) Inventors: David Edgar, Upholland, Lancashire (GB); Matthew Wroe, Leeds (GB); Milos Bozic, Marsh, Huddersfield (GB)

(73) Assignee: THREE SMITH GROUP LIMITED, Elland, West Yorkshire (GB)

(21) Appl. No.: 18/870,076

(22) PCT Filed: May 31, 2023
(86) PCT No.: PCT/GB2023/051438

§ 371 Date: Nov. 27, 2024

(30) Foreign Application Priority Data
Jun. 1, 2022 (GB) 2208136.8

(51) Int. Cl. G01S 13/931; B66F 9/06; B66F 9/075; G01S 13/87; G06K 7/10; G06K 19/02; G06K 19/07

(52) U.S. Cl. CPC G01S 13/931; B66F 9/063; B66F 9/0755; G01S 13/878; G06K 7/10099; G06K 7/10376; G06K 19/027; G06K 19/0723; G01S 2013/932; G01S 2013/9329

(57) ABSTRACT

A controller (213) for monitoring pedestrians in a warehouse, wherein the controller is configured to: receive first-RFID-signalling (214) from a first RFID antenna (211) mounted on a vehicle (210); receive second-RFID-signalling (215) from a second RFID antenna (212) mounted on the vehicle (210), wherein a field of view of the first RFID antenna (211) is spaced apart from a field of view of the second RFID antenna (212) in a first dimension; identify an RFID-tag-signal (216) from an RFID tag (218) that is associated with a pedestrian in the first-RFID-signalling (214); identify an RFID-tag-signal (216) from the RFID tag (218) that is associated with the pedestrian in the second-RFID-signalling (215); and determine a location of the pedestrian with reference to the vehicle (210) based on the RFID-tag-signals in both the first-RFID-signalling (241) and the second-RFID-signalling (215).

### FIELD

The present disclosure relates to a pedestrian monitoring system for a warehouse. In particular, to such a system that can Improve the safety of pedestrians in the warehouse.

### SUMMARY

According to a first aspect of the present disclosure, there is provided a controller for monitoring pedestrians in a warehouse, wherein the controller is configured to:
receive first-RFID-signalling from a first RFID antenna mounted on a vehicle;
receive second-RFID-signalling from a second RFID antenna mounted on the vehicle, wherein a field of view of the first RFID antenna is spaced apart from a field of view of the second RFID antenna in a first dimension;
identify an RFID-tag-signal from an RFID tag that is associated with a pedestrian in the first-RFID-signalling;
identify an RFID-tag-signal from the RFID tag that is associated with the pedestrian in the second-RFID-signalling; and
determine a location of the pedestrian with reference to the vehicle based on the RFID-tag-signals in both the first-RFID-signalling and the second-RFID-signalling.

The controller may be further configured to: provide an output-signal based on the determined location of the pedestrian.

The controller may be further configured to: compare the signal strength of the RFID-tag-signal in the first-RFID-signalling with the signal strength of the RFID-tag-signal in the second-RFID-signalling in order to determine the location of the pedestrian with respect to the vehicle in the first dimension.

The controller may be further configured to: identify a plurality of RFID-tag-signals from the RFID tag in the first-RFID-signalling over a period of time; identify a plurality of RFID-tag-signals from the RFID tag in the second-RFID-signalling over the period of time; determine a movement of the pedestrian with reference to the vehicle based on the plurality of RFID-tag-signals in both the first-RFID-signalling and the second-RFID-signalling; and provide an output-signal based on the determined movement of the pedestrian.

The controller may be configured to determine if the pedestrian is moving towards or away from the vehicle.

The controller may be further configured to provide an output-signal based on: the determined movement of the pedestrian; and the determined location of the pedestrian.

The controller may be further configured to:
identify a plurality of RFID-tag-signals from a respective plurality of RFID tags that are associated with a pedestrian in the first-RFID-signalling;
identify a plurality of RFID-tag-signals from the respective plurality of RFID tags that are associated with the pedestrian in the second-RFID-signalling; and
determine the location of the pedestrian with reference to the vehicle based on the plurality of RFID-tag-signals in both the first-RFID-signalling and the second-RFID-signalling.

The controller may be further configured to:
determine the location of the pedestrian with reference to the vehicle based on the plurality of RFID-tag-signals in both the first-RFID-signalling and the second-RFID-signalling only if at least a threshold number of RFID-tag-signals from respective RFID tags are identified in both the first-RFID-signalling and the second-RFID-signalling.

Each of the plurality of RFID-tag-signals may include: a garment-identifier that is associated with a garment that can be worn by the pedestrian.

The garment may be an item of personal protective equipment (PPE), such as: a high-visibility garment; a high-visibility vest/jacket; safety glasses; ear defenders; a helmet/hard hat; steel toe-capped boots.

Each of the plurality of RFID-tag-signals may further include: a garment-position-identifier that is indicative of a position on the garment at which the respective RFID tag is attached.

The garment-position-identifier may be indicative of whether the respective RFID tag is attached to the front or the back of the garment.

The controller may be further configured to:
identify a plurality of RFID-tag-signals from a respective plurality of RFID tags in each of the first-RFID-signalling and the second-RFID-signalling that have the same garment-identifier;
process the garment-position-identifier in each of the identified plurality of RFID-tag-signals to determine an orientation of the pedestrian that is wearing the garment with respect to the vehicle; and
provide an output-signal based on the determined orientation of the pedestrian.

The controller may be configured to:
compare: (i) the signal strength of the RFID-tag-signals in the first-RFID-signalling and the second-RFID-signalling associated with RFID tags at a first position on the garment; with (ii) the signal strength of the RFID-tag-signals in the first-RFID-signalling and the second-RFID-signalling associated with RFID tags at a second position on the garment, in order to determine the orientation of the pedestrian that is wearing the garment with respect to the vehicle.

The controller may be further configured to: identify the RFID-tag-signal in each of the first-RFID-signalling and the second-RFID-signalling only if the RFID-tag-signal has a signal strength that is greater than a threshold value.

The controller may be further configured to: identify the RFID-tag-signal in each of the first-RFID-signalling and the second-RFID-signalling only if the RFID-signalling includes at least a threshold number of RFID-tag-signals from the RFID tag over a predetermined period of time.

The controller may be configured to:
identify the RFID-tag-signal from the RFID tag in each of the first-RFID-signalling and the second-RFID-signalling only if:
   the RFID-signalling includes at least a threshold number of RFID-tag-signals from the RFID tag over a predetermined period of time (e.g. minimum number of reads/pings over a predetermined period of time); and
   each of the threshold number of the RFID-tag-signals from the RFID tag has a signal strength that is greater than a threshold value.

The controller may be configured to:
identify the RFID-tag-signal from the RFID tag in each of the first-RFID-signalling and the second-RFID-signalling only if:
   the RFID-signalling includes at least a threshold number of RFID-tag-signals from the RFID tag over a predetermined period of time (e.g. minimum number of reads/pings over a predetermined period of time); and
   the average signal strength of the threshold number of the RFID-tag-signals from the RFID tag is greater than a threshold value.

The controller may be further configured to:
receive a vehicle-speed-signal that represents the speed of the vehicle;
provide an output-signal based on: the determined location of the pedestrian; and the vehicle-speed-signal.

The controller may be configured to:
receive a vehicle-direction-signal that represents the direction of travel of the vehicle;
provide an output-signal based on: the determined location of the pedestrian; and the vehicle-direction-signal.

The controller may be configured to:
receive a vehicle-future-location-signal that represents a future location of the vehicle;
provide an output-signal based on: the determined location of the pedestrian; and the vehicle-future-location-signal.

The controller may be configured to:
receive third-RFID-signalling from a third RFID antenna mounted on the vehicle, wherein a field of view of the third RFID antenna is offset from the field of view of at least one of the first RFID antenna and the second RFID antenna in a second dimension that is transverse to the first dimension;
identify an RFID-tag-signal from the RFID tag that is associated with the pedestrian in the third-RFID-signalling; and
determine a location of the pedestrian with reference to the vehicle based on the RFID-tag-signals in each of the first-RFID-signalling, the second-RFID-signalling and the third-RFID-signalling.

The controller may be further configured to:
receive third-RFID-signalling from a third RFID antenna mounted on the vehicle, wherein a field of view of the third RFID antenna is offset from the field of view of at least one of the first RFID antenna and the second RFID antenna in a second dimension that is transverse to the first dimension;
receive fourth-RFID-signalling from a fourth RFID antenna mounted on the vehicle, wherein a field of view of the fourth RFID antenna is offset from the field of view of at least one of the first RFID antenna and the second RFID antenna in the second dimension;
identify an RFID-tag-signal from the RFID tag that is associated with the pedestrian in the third-RFID-signalling;
identify an RFID-tag-signal from the RFID tag that is associated with the pedestrian in the fourth-RFID-signalling; and
determine a location of the pedestrian with reference to the vehicle based on the RFID-tag-signals in each of the first-RFID-signalling, the second-RFID-signalling, third-RFID-signalling and the fourth-RFID-signalling.

According to a further aspect of the present disclosure, there is provided a pedestrian monitoring system for a warehouse, the system comprising:
a first RFID antenna mounted on a vehicle;
a second RFID antenna mounted on the vehicle, wherein a field of view of the first RFID antenna is spaced apart from a field of view of the second RFID antenna in a first dimension; and
a controller configured to:
   receive first-RFID-signalling from the first RFID antenna;
   receive second-RFID-signalling from the second RFID antenna;
   identify an RFID-tag-signal from an RFID tag that is associated with a pedestrian in the first-RFID-signalling;
   identify an RFID-tag-signal from the RFID tag that is associated with the pedestrian in the second-RFID-signalling; and
   determine a location of the pedestrian with reference to the vehicle based on the RFID-tag-signals in both the first-RFID-signalling and the second-RFID-signalling.

The system may further comprise a third RFID antenna having a field of view that is offset from the field of view of at least one of the first RFID antenna and the second RFID antenna in a second dimension that is transverse to the first dimension.

The system may further comprise:
a third RFID antenna having a field of view which is offset from the field of view of at least one of the first RFID antenna and the second RFID antenna along a second dimension that is transverse to the first dimension; and optionally
a fourth RFID antenna having a field of view of which is offset from the field of view of at least one of the first RFID antenna and the second RFID antenna along the second dimension that is transverse to the first dimension.

The field of view of the third RFID may be offset from the field of view of at least one of the first RFID antenna and the second RFID antenna along a first direction in the second dimension. The field of view of the fourth RFID antenna may be offset from the field of view of at least one of the first RFID antenna and the second RFID antenna along a second direction in the second dimension. The first direction is different to the second direction.

The field of view of the third RFID antenna may be offset from the field of view of at least one of the first RFID antenna and the second RFID antenna along a first direction in the second dimension. The field of view of the fourth RFID antenna may be offset from the field of view of at least one of the first RFID antenna and the second RFID antenna along a second first direction in the second dimension. For example, the four antennas may be located at each corner of the vehicle.

The system may further comprise: a speed sensor that is configured to provide a vehicle-speed-signal that represents the speed of the vehicle.

The system may further comprise:
a safety vest for wearing in the warehouse, the vest comprising:
   a plurality of RFID tags, on a front portion of the safety vest, for providing the RFID-tag-signal to the first RFID antenna; and
   a plurality of RFID tags, on a back portion of the safety vest, for providing the RFID-tag-signal to the first RFID antenna.

According to a further aspect of the present disclosure, there is provided a method of monitoring pedestrians in a warehouse, wherein the method comprises:
receiving first-RFID-signalling from a first RFID antenna mounted on a vehicle;
receiving second-RFID-signalling from a second RFID antenna mounted on the vehicle, wherein a field of view of the first RFID antenna is spaced apart from a field of view of the second RFID antenna in a first dimension;
identifying an RFID-tag-signal from an RFID tag that is associated with a pedestrian in the first-RFID-signalling;
identifying an RFID-tag-signal from the RFID tag that is associated with the pedestrian in the second-RFID-signalling; and
determining a location of the pedestrian with reference to the vehicle based on the RFID-tag-signals in both the first-RFID-signalling and the second-RFID-signalling.

According to a further aspect of the present disclosure, there is provided a controller for monitoring pedestrians in a warehouse, wherein the controller is configured to:
receive first-RFID-signalling from a first RFID antenna associated with a pedestrian access point in a warehouse;
identify that a pedestrian is passing, has passed, or is about to pass, through the pedestrian access point, and in response:
   process the first-RFID-signalling to identify any RFID-tag-signals from one or more respective RFID tags that: are associated with the pedestrian identified as passing through the pedestrian access point; and include a PPE-identifier that is associated with an item of PPE that can be worn by the pedestrian;
   determine whether or not any identified RFID-tag-signals represent a complete set of PPE items for the pedestrian; and
   generate an alert-output-signal if an incomplete set of PPE items is determined.

The controller may be further configured to:
process the signal strength of any identified RFID-tag-signals over time in order to determine movement of the associated RFID tags relative to the first RFID antenna; and
process the determined movement of any RFID tags to identify any RFID-tag-signals that are associated with the pedestrian identified as passing through the pedestrian access point.

The controller may be further configured to: compare the items of PPE that are associated with the identified RFID-tag-signals with a list of items of PPE that are required.

The controller may be configured to generate a PPE-complete-output-signal if a complete set of PPE items is determined.

The alert-output-signal may include details of the item or items of PPE that have not been detected.

The first RFID antenna may have a field of view associated with a first entrance/exit side of the pedestrian access point in the warehouse. The controller may be further configured to:
receive second-RFID-signalling from a second RFID antenna that has a field of view associated with a second entrance/exit side of the pedestrian access point;
process the first-RFID-signalling and the second-RFID-signalling to identify any RFID-tag-signals from one or more respective RFID tags in the first-RFID-signalling and the second-RFID-signalling that are: associated with the pedestrian identified as passing through the pedestrian access point; and include a PPE-identifier that is associated with an item of PPE that can be worn by the pedestrian; and
determine whether or not any identified RFID-tag-signals in the first-RFID-signalling and the second-RFID-signalling represent the complete set of PPE items for the pedestrian.

According to a further aspect of the present disclosure, there is provided a pedestrian monitoring system for a warehouse, the system comprising:
a first RFID antenna associated with a pedestrian access point in a warehouse;
a controller configured to:
   receive first-RFID-signalling from the first RFID antenna;
   identify that a pedestrian is passing, has passed, or is about to pass, through the pedestrian access point, and in response:
      process the first-RFID-signalling to identify any RFID-tag-signals from one or more respective RFID tags that: are associated with the pedestrian identified as passing through the pedestrian access point; and include a PPE-identifier that is associated with an item of PPE that can be worn by the pedestrian;
      determine whether or not any identified RFID-tag-signals represent a complete set of PPE items for the pedestrian; and
      generate an alert-output-signal if an incomplete set of PPE items is determined.

The system may further comprise:
a safety vest for wearing in the warehouse, the vest comprising:
   a plurality of RFID tags, on a front portion of the safety vest, for providing the RFID-tag-signal to the first RFID antenna; and
   a plurality of RFID tags, on a back portion of the safety vest, for providing the RFID-tag-signal to the first RFID antenna.

According to a further aspect of the present disclosure, there is provided a method of monitoring pedestrians in a warehouse, wherein the method comprises:
receiving first-RFID-signalling from a first RFID antenna associated with a pedestrian access point in a warehouse;
identifying that a pedestrian is passing, has passed, or is about to pass, through the pedestrian access point, and in response:
   processing the first-RFID-signalling to identify any RFID-tag-signals from one or more respective RFID tags that: are associated with the pedestrian identified as passing through the pedestrian access point; and include a PPE-identifier that is associated with an item of PPE that can be worn by the pedestrian;
   determining whether or not any identified RFID-tag-signals represent a complete set of PPE items for the pedestrian; and
   generating an alert-output-signal if an incomplete set of PPE items is determined.

According to a further aspect of the present disclosure, there is provided a safety vest for wearing in a warehouse, the vest comprising:
a plurality of RFID tags on a front portion of the vest; and
a plurality of RFID tags on a back portion of the vest;
   wherein:
each of the RFID tags has an associated spacer that is between the RFID tag and a person when the safety vest is worn by the person.

The spacer may be at least 12 mm thick, and optionally at least 16 mm thick.

Each of the RFID tags may include an identifier that it provides as part of an RFID-tag-signal when it is excited by an RFID antenna.

The identifier may comprise one or more of:
a product-type-identifier, which is indicative of the type of safety vest with which the RFID tag is associated;
a vest-identifier, which is a unique identifier of the vest with which the RFID tag is associated;
a unique-tag-identifier, which is a unique identifier for each RFID tag on any given safety vest,

There may be provided a computer program, which when run on a computer, causes the computer to configure any apparatus, including a controller, system or device disclosed herein or perform any method disclosed herein. The computer program may be a software implementation, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software may be an assembly program.

The computer program may be provided on a computer readable medium, which may be a physical computer readable medium such as a disc or a memory device, or may be embodied as a transient signal. Such a transient signal may be a network download, including an internet download. There may be provided one or more non-transitory computer-readable storage media storing computer-executable instructions that, when executed by a computing system, causes the computing system to perform any method disclosed herein.

### BRIEF DESCRIPTION OF THE DRAWINGS

One or more embodiments will now be described by way of example only with reference to the accompanying drawings in which:

FIG. 1 shows schematically a plan view of part of the inside of a warehouse, which is a suitable environment in which a damage detection system that is described herein can be used;

FIGS. 2a and 2b show an example embodiment of a pedestrian monitoring system for a warehouse;

FIG. 3 shows another example embodiment of a pedestrian monitoring system for a warehouse;

FIG. 4 shows a system for monitoring pedestrians in a warehouse, which is used for detecting a pedestrian that is not wearing a complete set of personal protective equipment (PPE);

FIG. 5 shows another example of a system for monitoring pedestrians in a warehouse as they pass through a pedestrian access point;

FIG. 6 shows a further still example of a system for monitoring pedestrians in a warehouse as they pass through a pedestrian access point;

FIGS. 7a and 7b illustrate an example embodiment of a safety vest for wearing in an industrial setting such as a warehouse;

FIG. 7c shows an example embodiment of an RFID tag and associated spacer that can be provided on the safety vest of FIGS. 7a and 7b;

FIG. 8 illustrates an example embodiment of a method of monitoring pedestrians in a warehouse; and

FIG. 9 illustrates another example embodiment of a method of monitoring pedestrians in a warehouse.

### DETAILED DESCRIPTION

Vehicle collisions can cause injury to persons, including the driver and pedestrians, and damage to structures and the vehicle itself. In a warehouse environment, vehicles may be required to move within confined spaces and in close proximity to valuable goods and personnel. For example, in a warehouse, forklift trucks (FLTs) may pass between aisles of racking or shelving that contain valuable stock. A FLT may have to perform tight turns and manoeuvres to load and unload stock from the racking. Even a skilled driver may accidently collide with pedestrians thereby creating a potential safety hazard. Therefore, it can be a requirement that pedestrians must wear suitable items of personal protective equipment (PPE), at least when they are in certain areas of the warehouse

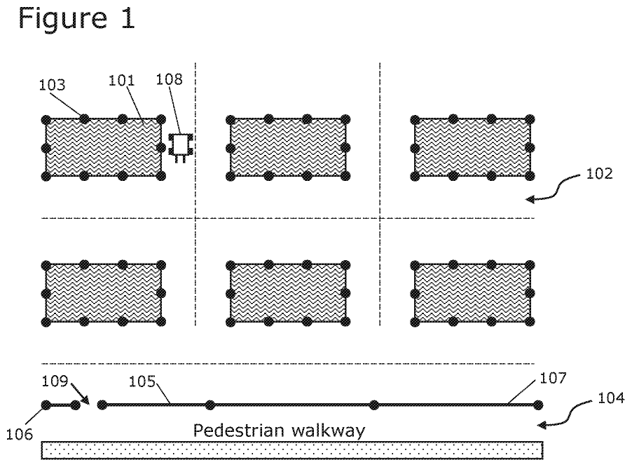

FIG. 1 shows schematically a plan view of part of the inside of a warehouse, which is a suitable environment in which a pedestrian monitoring system that is described herein can be used. FIG. 1 shows six banks of racking 101, with aisles 102 in between each bank 101. As shown in FIG. 1, a forklift truck (FLT) 108 can drive along the aisles in order to access stock that is stored in different banks of racking 101. Each bank of racking 101 has a plurality of racking legs 103. A racking leg 103 is a vertical support that is used to support shelving or pallets. The banks of racking 101 can also include beams (that are generally horizontal) and/or braces (that extend generally diagonally with reference to the ground).

FIG. 1 also shows that a part of the warehouse is designated as a pedestrian walkway 104. The pedestrian walkway 104 is separated from an end aisle of racking by a barrier 105. In this example, the barrier 105 is shown as including a plurality of spaced apart posts 106, with rails 107 joining the majority of the adjacent posts 106. A pedestrian access point 109 is shown as a gap in the barrier, through which a pedestrian can walk to move between the pedestrian walkway 104 and a part of the warehouse in which the FLT 108 operates. In some circumstances, the PPE requirements for a pedestrian that is in the pedestrian walkway 104 can be different to those for a pedestrian in the part of the warehouse in which the FLT 108 operates. Further examples of pedestrian access points to the warehouse include doorways and turnstiles, which may be external such that they provide access to the warehouse from outside the building or may be internal such that they provide access between different parts of the warehouse.

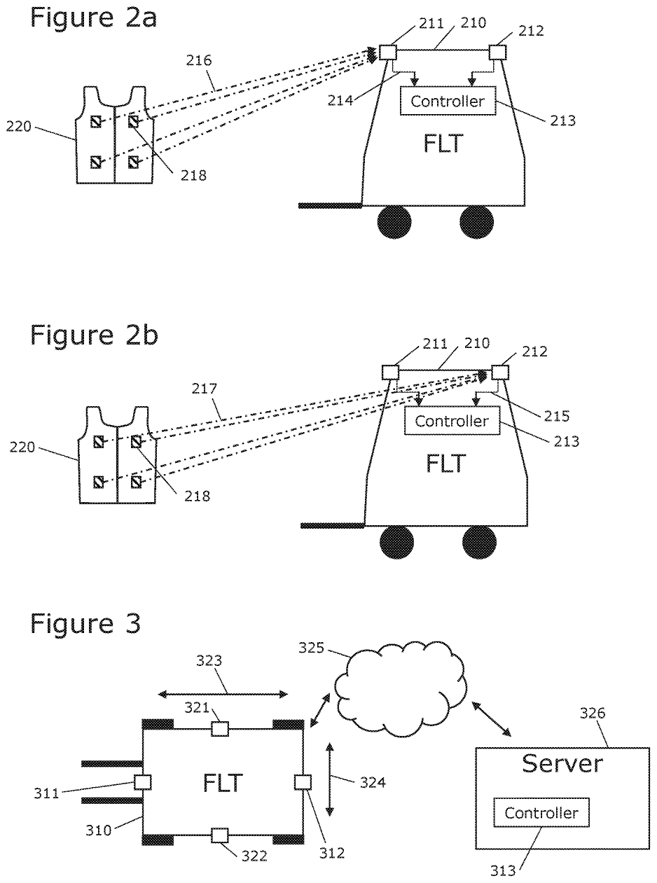

FIGS. 2a and 2b show an example embodiment of a pedestrian monitoring system for a warehouse. In this example, the pedestrian monitoring system is associated with a forklift truck (FLT) 210, although it will be appreciated that it can also be associated with other types of vehicle that move around a warehouse.

The system includes a first RFID scanner 211 and a second RFID scanner 212 mounted on the FLT 210. Such RFID scanners can also be referred to as RFID antennas or RFID readers and they are well-known in the art. For instance, the first RFID scanner 211 and the second RFID scanner 212 can be implemented as separate RFID antennas that share a single RFID module/chip, such that the single RFID module/chip can multiplex between the signals provided by the multiple RFID antennas.

A field of view of the first RFID scanner 211 is spaced apart from a field of view of the second RFID scanner 212 in a first dimension. In this example, the first dimension is a longitudinal dimension of the FLT 210 such that, as will be discussed below, the system can detect whether pedestrians are in front of or behind the FLT 210. In another example, the first dimension is a lateral dimension of the FLT 210 such that the system can detect whether pedestrians are on the left or the right of the FLT 210. As a further example still, as will be discussed below, the system may include more than two RFID scanners such that it can determine the location of pedestrians with reference to the FLT 210 in two dimensions.

The fields of view of RFID scanners can be spaced apart or offset from each other by mounting them in different physical locations, such as on different parts of the FLT 210 as shown in FIGS. 2a to 2c. The RFID scanners can be substantially omnidirectional such that their fields of view overlap, yet are still considered spaced apart. Alternatively, the RFID scanners can be directional such that their fields of view are spaced apart due to the directionality of the RFID scanners. In which case, the RFID scanners/antennas need not necessarily be physically offset from each other to achieve a spacing apart of their fields of view.

The system also includes a controller 213 which may also be referred to as a RFID module or a RFID chip. In this example the controller 213 is Illustrated as local to the FLT 210, although in other examples some or all of the functionality of the controller can be implemented by devices/components that are remote from the FLT 210.

The controller 213 receives first-RFID-signalling 214 from the first RFID scanner 211 (as labelled in FIG. 2a) and it receives second-RFID-signalling 215 from the second RFID scanner 212 (as labelled in FIG. 2b). It will be appreciated that the controller 213 receives first-RFID-signalling 214 and the second second-RFID-signalling 215 simultaneously, and that they are only shown separately in FIGS. 2a and 2b to more clearly illustrate the functionality of the pedestrian monitoring system.

The controller 213 can identify an RFID-tag-signal 216 from an RFID tag 218 that is associated with a pedestrian in the first-RFID-signalling 214. In this example, four RFID tags 218 associated with a pedestrian are shown. The four RFID tags 218 are associated with a garment 220 (in this example a high-visibility safety vest) that can be worn by the pedestrian. Each of the four RFID tags 218 can be excited by the first RFID scanner 211 such that they each provide an RFID-tag-signal 216 that is received at the first RFID scanner 211. Therefore, each of the four RFID-tag-signals 216 is present in the first-RFID-signalling 214.

In this example the RFID tags 218 are passive, which is advantageous because batteries to not have to be provided in the garment 220 such that they do not need to be periodically recharged or replaced.

The controller 213 can also identify an RFID-tag-signal 217 from the RFID tag 218 that is associated with the pedestrian in the second-RFID-signalling 215 in the same way as described above with reference to the identification of an RFID-tag-signal 216 in the first-RFID-signalling 214. As shown, the controller 213 identifies RFID-tag-signals 216, 217 from the same RFID tags 218 in both the first-RFID-signalling 214 and the second-RFID-signalling 215.

The controller 213 can then determine a location of the pedestrian with reference to the FLT 210 based on the RFID-tag-signals in both the first-RFID-signalling 214 and the second-RFID-signalling 215. The location of the pedestrian can be determined in a number of ways, including the determination of a signal strength of the RFID-tag-signal 216 in the first-RFID-signalling 214 and the signal strength of the RFID-tag-signal 217 in the second-RFID-signalling 215 as will be discussed below.

Advantageously, determining the location of the pedestrian using RFID-signalling from two RFID scanners 211, 212 in this way enables the controller to more accurately determine the location of the pedestrian, especially in the first dimension. As indicated above, and as will be described further below, the first dimension can be the longitudinal dimension of the FLT 210 such that a determination can be made as to whether the pedestrian is in front of or behind the FLT 210, in which case different subsequent actions can be taken to improve the safety of the pedestrian. Similarly, if the first dimension is the lateral dimension of the FLT 210 then a determination can be made as to whether the pedestrian is on the right or left of the FLT 210, which information can again be used to take different subsequent actions to improve the safety of the pedestrian.

In some examples, the controller 213 can provide an output-signal based on the determined location of the pedestrian. For instance, the output-signal can cause an alert to be generated for the operator of the FLT 210 such that they are aware of the presence of the pedestrian. Additionally or alternatively, the output-signal can cause an alert to be generated for the pedestrian such that they are aware of the presence of the FLT 210. Either way, providing such an alert can reduce the risk of the FLT 210 colliding with the pedestrian. Such alerts can be one or more of an audio alert, a visual alert and a haptic alert. Alternatively or additionally, the output-signal can operate an actuator associated with the FLT 210 to reduce the risk of a collision; for example, to reduce the speed of the FLT 210 or to steer it away from the pedestrian. As a further example, the output-signal can cause a record of the detected pedestrian location to be stored in a log in computer memory. Such a log can be used to better understand the interactions between pedestrians and the FLT 210 such that the warehouse can be designed in a way that mitigates risks and/or such that training can be provided to improve the safety of the warehouse.

One way in which the controller 213 can determine the location of the pedestrian is by processing the signal strength/power of the received RFID-tag-signals 216, 217. One example of how the signal strength can be represented is a Received Signal Strength Indicator (RSSI) for the received RFID-tag-signals 216, 217. The controller 213 can compare the signal strength of the RFID-tag-signal 216 in the first-RFID-signalling 214 with the signal strength of the RFID-tag-signal 217 in the second-RFID-signalling 215 in order to determine the location of the pedestrian with respect to the vehicle in the first dimension. By comparing the signal strengths in this way, the controller 213 can determine if the associated RFID tag 218 is closer to the first RFID scanner 211 or the second RFID scanner 212, and therefore it can determine the relative location of the associated pedestrian in the first dimension (the dimension along with the first and second RFID scanners 211, 212 are offset). For example, if the first and second RFID scanners 211, 212 are offset along a longitudinal dimension of the FLT 210 (as shown in FIGS. 2a and 2b), and the signal strength of the RFID-tag-signal 216 in the first-RFID-signalling 214 is greater than the signal strength of the RFID-tag-signal 217 in the second-RFID-signalling 215, then the controller 213 can determine that the pedestrian is closer to the front of the FLT 210 than the back of the FLT 210.

In some examples, the first and second RFID scanners 211, 212 may be directional RFID scanners 211, 212, that have a field of view biased towards a particular direction. For example, in the example of FIGS. 2a and 2b, the first RFID scanner 211 may comprise a directional RFID scanner with a field of view directed outward from the front of the FLT 210 and the second RFID scanner 212 may comprise a directional RFID scanner with a field of view directed outward from the rear of the FLT 210. In other words, the fields of view of each RFID scanner 211, 212 are directed away from the other RFID scanner. In this way, the difference in signal strength between the RFID-tag-signal 216 in the first-RFID-signalling 214 and the RFID-tag-signal 217 in the second-RFID-signalling 215 can be magnified to improve sensitivity and accuracy.

In one example, different output-signals can be provided for different determined locations of the pedestrian. For instance, a high-alert-output-signal can be provided for a determined first location, such as one that is considered a relatively high risk of a collision. An example of such a first location is the pedestrian being in front of the FLT 210, or on any particular side of the FLT 210 that is considered high risk. A low-alert-output-signal (or no output-signal) can be provided for a determined second location. An example of such a second location is the pedestrian being behind the FLT 210, or on any particular side of the FLT 210 that is considered low risk.

The controller 213 of FIGS. 2a and 2b can be used to track the location of the pedestrian associated with the RFID tags 218 over time, and therefore it an be used to determine the movement of the pedestrian with reference to the FLT 210. To do this, the controller 213 can: identify a plurality of RFID-tag-signals 216 from the RFID tag 218 in the first-RFID-signalling 214 over a period of time; and identify a plurality of RFID-tag-signals 217 from the RFID tag 218 in the second-RFID-signalling 215 over the period of time. The controller 213 can then determine a movement of the pedestrian with reference to the FLT 210 based on the plurality of RFID-tag-signals 216, 217 in both the first-RFID-signalling 214 and the second-RFID-signalling 215.

More particularly, the controller 213 can process the signal strength of the RFID-tag-signals 216, 217 in both the first-RFID-signalling 214 and the second-RFID-signalling 215 over time to determine if the tag 218 (and therefore also the associated pedestrian) is getting closer to, or further away from, each of the first RFID scanner 211 and the second RFID scanner 212. In this way, the controller 213 can determine if the pedestrian is moving towards or away from the FLT 210 along the first dimension (i.e. the dimension along with the two RFID scanners 211, 212 are offset), Where the first RFID scanner 211 and the second RFID scanner 212 are spaced apart along the longitudinal length of the FLT, the controller 213 can determine if the pedestrian is moving towards or away from the front or back of the FLT 210.

Advantageously, the controller 213 can then provide an output-signal based on the determined movement of the pedestrian. For example, the controller 213 can provide a high-alert-output-signal if the pedestrian is moving towards the FLT 210. The controller 213 can provide a low-alert-output-signal (or no output-signal) if the pedestrian is moving away from the FLT 210. As a further example, the controller 213 can provide the output-signal based on: the determined movement of the pedestrian; and also the determined location of the pedestrian. In this way, for example, the particularly dangerous scenario a pedestrian moving towards the front of the FLT 210 can be detected, and the controller 213 can provide an appropriate output-signal accordingly.

As shown in FIGS. 2a and 2b, a plurality of RFID tags 218 can be associated with the same pedestrian. In the example of FIGS. 2a and 2b, the plurality of RFID tags 218 are associated with a single garment that is worn by a pedestrian. In such an example, the controller can: identify a plurality of RFID-tag-signals 216 from a respective plurality of RFID tags 218 that are associated with a pedestrian in the first-RFID-signalling 214; and identify a plurality of RFID-tag-signals 217 from the respective plurality of RFID tags 218 that are associated with the pedestrian in the second-RFID-signalling 215. The controller 213 can then determine the location of the pedestrian with reference to the FLT 210 based on the plurality of RFID-tag-signals 216, 217 (from the plurality of RFID tags 218) in both the first-RFID-signalling 214 and the second-RFID-signalling 215. Advantageously, using a plurality of RFID-tag-signals 216, 217 from a plurality of RFID tags 218 can improve the accuracy/reliability of the determined location of the pedestrian.

The reliability of the determined location of the pedestrian can be improved further by the controller 213 determining the location of the pedestrian with reference to the FLT 210 based on the plurality of RFID-tag-signals 216, 217 in both the first-RFID-signalling 214 and the second-RFID-signalling 215 only if at least a threshold number of RFID-tag-signals 216, 217 from respective RFID tags 218 are identified in both the first-RFID-signalling 214 and the second-RFID-signalling 215. In this way, a location is only determined if a minimum number of RFID tags 218 are identified. This can reduce the likelihood of the controller 213 determining the location of a pedestrian based on only a small number of spurious RFID-tag-signals 216, 217 being received at the RFID scanners 211, 212, or based on RFID-tag-signals 216, 217 being received at only one of the RFID scanners 211, 212.

In this example, each of the plurality of RFID-tag-signals 216 includes a garment-identifier that is associated with a garment that can be worn by the pedestrian. In FIGS. 2a and 2b the RFID tags 218 are associated with a high-visibility safety vest, as one example of a garment. More generally, the garment can be any item of personal protective equipment (PPE), such as: a high-visibility garment; a high-visibility jacket; safety glasses; ear defenders; a helmet/hard hat; steel toe cap boots, etc., The garment-identifier can be unique for individual garments (for instance, unique garment-identifiers can be used for each high-visibility safety vest, unique garment-identifiers can be used for each pair of safety glasses, etc.).

The controller 213 can then identify a plurality of RFID-tag-signals 216, 217, from a respective plurality of RFID tags 218 in each of the first-RFID-signalling 214 and the second-RFID-signalling 215, that have the same garment-identifier, and identify a single location of the pedestrian for all of the RFID-tag-signals 216, 217 that have the same garment-identifier and therefore are located on the same garment.

In some examples, the controller 213 may have access to a database that associates a plurality of garment-identifiers, for different items of PPE, with a single pedestrian. For instance, each pedestrian may have their own specific items of PPE that only they use. By interrogating such a database using garment-identifiers that are recognised in the received RFID-tag-signals 216, 217, the controller 213 can identify a single location of the pedestrian for all of the RFID-tag-signals 216, 217 that have a garment-identifier that is associated with a single pedestrian.

Further still, in this example, each of the plurality of RFID-tag-signals 216 includes a garment-position-identifier that is indicative of a position on the garment at which the respective RFID tag 218 is attached. For instance, the garment-position-identifier can be indicative of whether the respective RFID tag 218 is attached to the front or the back of the garment. The garment-position-identifier may be in addition to, or instead of, a garment-identifier. In such an example, the controller 213 can: identify a plurality of RFID-tag-signals 216, 217 from a respective plurality of RFID tags 218 in each of the first-RFID-signalling 214 and the second-RFID-signalling 215 that have the same garment-identifier; and process the garment-position-identifier in each of the identified plurality of RFID-tag-signals 216, 217 to determine an orientation of the pedestrian that is wearing the garment with respect to the vehicle.

For instance, if the signal strength of RFID-tag-signals 216, 217 from RFID tags 218 at the front of the garment is higher than the signal strength of RFID-tag-signals 216, 217 from RFID tags 218 at the back of the garment, then the controller 213 can determine that the pedestrian is facing the FLT 210. More generally, the controller 213 can compare: (i) the signal strength of the RFID-tag-signals 216, 217 in the first-RFID-signalling 214 and the second-RFID-signalling 215 associated with RFID tags 218 at a first position on the garment; with (ii) the signal strength of the RFID-tag-signals 216, 217 in the first-RFID-signalling 214 and the second-RFID-signalling 215 associated with RFID tags 218 at a second position on the garment, in order to determine the orientation of the pedestrian that is wearing the garment with respect to the FLT 210.

As another example, if only RFID-tag-signals 216, 217 from RFID tags 218 at the front of the garment are identified by the controller 213, or if more RFID-tag-signals 216, 217 from RFID tags 218 at the front of the garment are identified than RFID-tag-signals 216, 217 from RFID tags 218 at the back of the garment, then the controller 213 can determine that the pedestrian is facing the FLT 210.

Advantageously, the controller 213 can provide an output-signal based on the determined orientation of the pedestrian. For instance: the controller 213 can provide a high-alert-output-signal for a first orientation of the pedestrian, such as the pedestrian having their back to the vehicle (an audio alert can be particularly beneficial for such an orientation); and the controller 213 can provide a low-alert-output-signal for a second orientation of the pedestrian, such as the pedestrian facing the vehicle (a visual alert can be particularly beneficial for such an orientation).

In some examples, the controller 213 can perform additional processing before it successfully identifies an RFID-tag-signal 216, 217 from an RFID tag 218 as suitable for use in determining a location of an associated pedestrian (or determining any other feature of the associated pedestrian that is disclosed herein).

In one instance, the controller 213 identifies the RFID-tag-signal 216, 217 in each of the first-RFID-signalling 214 and the second-RFID-signalling 215 only if the RFID-tag-signal 216, 217 has a signal strength that is greater than a threshold value. In this way, weak RFID-tag-signals 216, 217, perhaps because they are too far away to warrant a location determination, can be ignored by the controller 213 when determining the location of a pedestrian.

In another instance, the controller 213 can identify the RFID-tag-signal 216, 217 in each of the first-RFID-signalling 214 and the second-RFID-signalling 215 only if they each include at least a threshold number of RFID-tag-signals 216, 217 from the RFID tag 218 over a predetermined period of time. In this way, the controller 213 must recognise a minimum number of reads/pings from an RFID tag 218 over the predetermined period of time before it is used to determine the location of the pedestrian. This process can help to mitigate against the incorrect calculation of the location of a pedestrian based on too few spuriously received RFID-tag-signals 216, 217, which can be considered as unlikely to actually relate to a pedestrian that is in the vicinity of the FLT 210.

In a yet further instance, the controller 213 can identify the RFID-tag-signal 216, 217 from the RFID tag in each of the first-RFID-signalling 214 and the second-RFID-signalling 215 only if: (i) they each include at least a threshold number of RFID-tag-signals 216, 217 from the RFID tag 218 over a predetermined period of time (as discussed above); and (ii) each of the threshold number of the RFID-tag-signals 216, 217 from the RFID tag 218 has a signal strength that is greater than a threshold value (also as discussed above). This can further improve the reliability of the location determination of the pedestrian for the corresponding reasons that are discussed above.

In a further instance still, the controller 213 can identify the RFID-tag-signals 216, 217 from the RFID tag 218 in each of the first-RFID-signalling 214 and the second-RFID-signalling 215 only if: (i) they include at least a threshold number of RFID-tag-signals 216, 217 from the RFID tag 218 over a predetermined period of time (as discussed above); and (ii) the average signal strength of the threshold number of the RFID-tag-signals 216, 217 from the RFID tag 218 is greater than a threshold value. This represents a yet further way of improving the reliability of the location determination.

In some examples, the controller 213 may still record RFID-tag-signals that do not meet one or more of the above threshold requirements. Such signals may relate to spurious single readouts of a pedestrian that is not in close proximity to the vehicle 210. Recording these signals can enable the controller 213 to infer a pedestrian is present in rough proximity and enable head-count logging of the number of people in a particular region of the warehouse at a particular point in time.

In some examples, the controller 213 can also receive a signal that represents a property of the vehicle/FLT 210. As will be discussed below, use of such a signal can enable an output-signal to be produced that is better tailored to be the actual risk of collision between the pedestrian and the FLT 210 for particular circumstances.

As one example, the controller 213 receives a vehicle-speed-signal that represents the speed of the FLT 210. A speed sensor associated with the FLT 210 can provide the vehicle-speed-signal. The controller 213 can then provide an output-signal based on: (i) the determined location of the pedestrian (as discussed above); and the vehicle-speed-signal. For instance, the controller 213 can provide a high-alert-output-signal if: the vehicle-speed-signal is greater than a threshold; and the determined location of the pedestrian is less than a threshold distance from the vehicle. The controller 213 can provide a lower-alert-output-signal if the vehicle-speed-signal is less than the threshold on the basis that that the likelihood of a collision is reduced if the FLT 210 is travelling slower.

As another example, the controller receives a vehicle-direction-signal that represents the direction of travel of the FLT 210. The controller 213 can then provide an output-signal based on: the determined location of the pedestrian (as discussed above); and the vehicle-direction-signal. For example, the vehicle-direction-signal can Include a component that corresponds to the first dimension (i.e. the dimension along with the first RFID scanner 211 and the second RFID scanner 212 are offset). Therefore, the controller 213 can determine if the direction of travel of the FLT 210 along the first dimension is towards the determined location of the pedestrian. In this way, the controller 213 can provide a high-alert-output-signal if the vehicle-direction-signal corresponds to (i.e. is towards or is likely to intercept with) the determined location of the pedestrian.

As a further still example, the FLT may be autonomously controlled or it may be driven along a predetermined path. Either way, the vehicle may have a pre-programmed path in the warehouse that it is going to take. In such an example, the controller 213 can receive a vehicle-future-location-signal that represents a future location of the FLT (I.e., according to the pre-programmed path). The controller 213 can then provide an output-signal based on: the determined location of the pedestrian (as discussed above); and the vehicle-future-location-signal. In the same way as described above, the controller 213 can provide a high-alert-output-signal if the vehicle-future-location-signal corresponds to (i.e. is likely to intercept with) the determined location of the pedestrian

FIG. 3 shows another example embodiment of a pedestrian monitoring system for a warehouse. In the same way as FIGS. 2a and 2b, in the example of FIG. 3 the pedestrian monitoring system is associated with a forklift truck (FLT) 310.

The system in this example includes a first RFID scanner 311, a second RFID scanner 312, a third RFID scanner 321 and a fourth RFID scanner 322, each mounted on the FLT 310. Each of the RFID scanners provides respective RFID-signalling to a controller 313. The controller 313 in this example is located remotely from the FLT 310 on a server 326. The four RFID scanners 311, 312, 321, 322 on the FLT 310 are in electronic communication with the server 326 over any network 325 that is known in the art, including the internet.

The first RFID scanner 311 is spaced apart from the second RFID scanner 312 in a first dimension, which in this example is the longitudinal dimension 323 of the FLT 310. The third RFID scanner 321 is offset from at least one of the first RFID scanner 311 and the second RFID scanner 312 in a second dimension that is transverse to the first dimension. In this example, the second dimension is the lateral dimension 324 of the FLT 310. The fourth RFID scanner 322 is also offset from at least one of the first RFID scanner 311 and the second RFID scanner 312 in the second/lateral dimension 324. Providing the four RFID scanners 311, 312, 321, 322 in this way can enable them to provide RFID-tag-signalling that enables the controller 313 to determine the location of a pedestrian (not shown) with reference to the FLT 310 in two orthogonal dimensions—i.e. the longitudinal dimension 323 and the lateral dimension 324.

The controller 313 can identify RFID-tag-signals from RFID tags (not shown) that are associated with the pedestrian in third-RFID-signalling that is received from the third RFID scanner 321. The controller 313 can also identify RFID-tag-signals from RFID tags that are associated with the pedestrian in fourth-RFID-signalling that is received from the fourth RFID scanner 322. In a similar way to that described above with reference to FIGS. 2a and 2b, the controller 313 can then determine a location of the pedestrian with reference to the FLT 310 based on the RFID-tag-signals in each of the first-RFID-signalling, the second-RFID-signalling, third-RFID-signalling and the fourth-RFID-signalling.

In this example, each of the four RFID scanners 311, 312, 321, 322 is located partway along a different side of the FLT 310. It will be appreciated that in other examples the four RFID scanners 311, 312, 321, 322 can be located at any positions on the FLT 310 such that they can resolve the location of a pedestrian with reference to the FLT 310 in the longitudinal dimension 323 and the lateral dimension 324. For instance, the four RFID scanners 311, 312, 321, 322 can be located at, or near, corners of the FLT 310.

It will also be appreciated that in other examples, three RFID scanners 311, 312, 321, 322 can be provided on the FLT in such a way that they can provide RFID-tag-signalling that enables the controller 313 to determine the location of a pedestrian with reference to the FLT 310 in two orthogonal dimensions. That is, the controller 313 can determine a location of the pedestrian with reference to the FLT 310 based on the RFID-tag-signals in each of the first-RFID-signalling, the second-RFID-signalling and the third-RFID-signalling.

It will further be appreciated that any of the properties of the pedestrian or any of the output-signals or other signals that are described with reference to FIGS. 2a and 2b as being calculated based on the first-RFID-signalling and the second-RFID-signal, can also be calculated for the system of FIG. 3 based on the first-RFID-signalling, the second-RFID-signalling and the third-RFID-signalling (and optionally also based on the fourth-RFID-signalling).

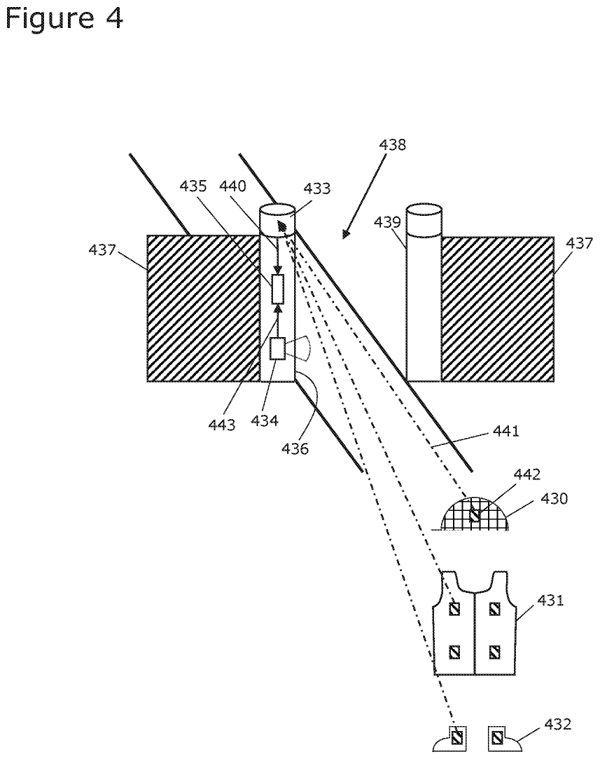

FIG. 4 shows a system for monitoring pedestrians in a warehouse, which is used for detecting a pedestrian that is not wearing a complete set of personal protective equipment (PPE) (e.g. for a particular region of the warehouse). As one example, a particular region of a warehouse may require a pedestrian to be wearing a helmet 430, a high-visibility safety vest 431 and a pair of steel toe cap boots 432. As will be discussed below, each of these types of PPE can be fitted with an RFID tag such that an incomplete set of PPE items can be determined and an associated alert-output-signal can be generated.

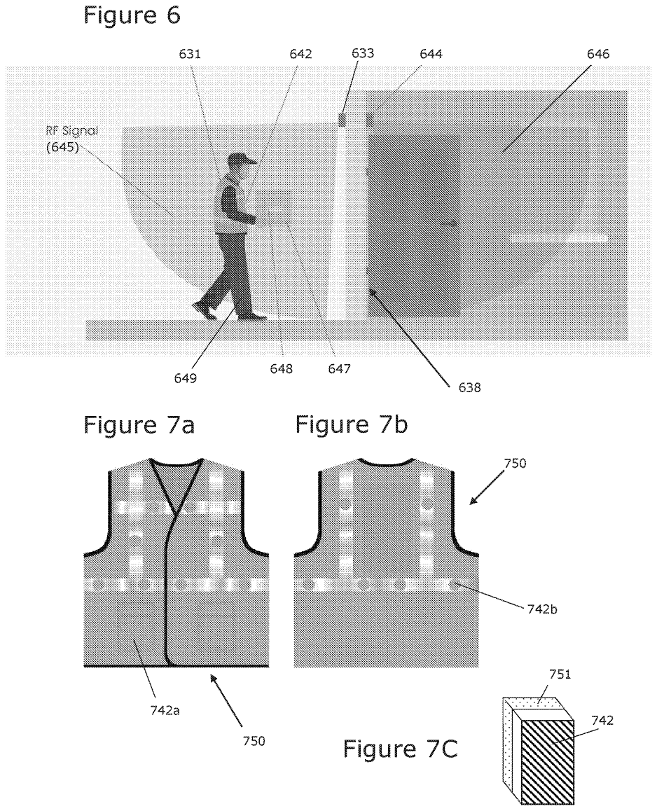

The system is associated with a pedestrian access point 438, which in this example is an opening between two posts 436, 439. Barriers 437 are provided on the other sides of the posts 436, 439 such that pedestrians are forced to pass between the two posts 436, 439 in order to pass through the pedestrian access point 438. It will be appreciated that the systems described herein can be provided with other types of pedestrian access points 438 such as doorways (as shown in FIG. 6), gates, etc. The pedestrian access point 438 may represent a boundary between different regions of the warehouse. For instance, a boundary between a region in which the pedestrian must be wearing PPE and a region in which PPE is not compulsory. Alternatively, the pedestrian access point 438 may represent a boundary between the inside of the warehouse and the outside the warehouse.

The system includes a first RFID scanner 433 (which in this example is the only RFID scanner), a pedestrian detector 434 and a controller 435.

The first RFID scanner 433 is associated with the pedestrian access point 438 in the warehouse such that it can perform a scan for RFID tags as they pass through the pedestrian access point 438, or shortly before or shortly after they pass through the pedestrian access point 438. In this example, the first RFID scanner 433 is provided as part of one of the posts 436. Although in other examples it can be mounted at any position such that it can detect RFID tags 442 as they pass through the pedestrian access point 438. The first RFID scanner 433 provides first-RFID-signalling 440 in the same way that is described above with reference to FIGS. 2a and 2b. If the first RFID scanner 433 detects any RFID tags 442, then the first-RFID-signalling 440 will include RFID-tag-signals 441 received from the detected RFID tags 442.

The pedestrian detector 434 can detect that a pedestrian is passing, has passed, or is about to pass, through the pedestrian access point 438. The pedestrian detector 434 can be implemented in a number of different ways; for example as: a camera that records images that can be image processed to detect the pedestrian; a motion detector; a passive infrared (PIR) sensor; or one or more RFID scanners (as will be discussed in more detail below). Irrespective of how the pedestrian detector 434 is implemented, it can provide pedestrian-detection-signalling 443 to the controller 435 that either indicates whether or not a pedestrian has been detected or can be processed by the controller 435 in order to determine whether or not a pedestrian has been detected.

Turning now to the controller 435, it receives the first-RFID-signalling 440 from the first RFID scanner 433. The controller 435 also receives the pedestrian-detection-signalling 443 such that it can detect that a pedestrian is passing, has passed, or is about to pass, through the pedestrian access point 438.

In response to detecting a pedestrian, the controller 435 processes the first-RFID-signalling 440 to identify any RFID-tag-signals 441 from one or more respective RFID tags 442 that are associated with the pedestrian identified as passing through the pedestrian access point. More particularly, it identifies any such RFID-tag-signals 441 that include a PPE-identifier. Such PPE-identifiers are associated with an item of PPE that can be worn by the pedestrian. The PPE-identifiers can be unique to a particular type of PPE (for instance, the same PPE-identifier can be used for all high-visibility safety vests, the same PPE-identifier can be used for all safety glasses, etc.). Alternatively, the PPE-identifier can be unique for individual items of PPE (for instance, unique PPE-identifiers can be used for each high-visibility safety vest, unique PPE-identifiers can be used for each pair of safety glasses, etc.).

The controller 435 can then determine whether or not any identified RFID-tag-signals 441 represent a complete set of PPE items for the pedestrian. For example, the controller 435 may have access to computer memory that stores a list of PPE-identifiers that are associated with the items of PPE that are required for a region of the warehouse that is located on at least one side of the pedestrian access point 438. The controller 435 can then compare the items of PPE that are associated with the identified RFID-tag-signals 441 (as defined by the associated PPE-identifiers) with the list in computer memory to determine if any items of PPE are missing from the identified RFID-tag-signals 441. (Even if PPE is required on only one side of the pedestrian access point 438, the system of FIG. 4 can ensure that pedestrians that are both entering and exiting the region of the warehouse that requires PPE have a complete set of PPE.)

The controller 435 can then generate an alert-output-signal if an incomplete set of PPE items is determined. Such an alert-output-signal can cause an audio alert, a visual alert and/or a haptic alert to be provided such that the pedestrian is notified that they do not have a complete set of PPE. In some examples, the alert-output-signal can also include details of the item or items of PPE that have not been detected such that this can also be notified to the pedestrian. As a further example still, the alert-output-signal can cause a record of the detection of an incomplete set of PPE to be stored in a log in computer memory.

In some examples, the controller 435 can generate a PPE-complete-output-signal if a complete set of PPE items is determined. This can be useful for providing reassurance to the pedestrian that they have all of the required Items of PPE. Further still, in some applications the PPE-complete-output-signal may be required for the pedestrian to be able to pass through the pedestrian access point 438. For instance, the PPE-complete-output-signal may cause a gate or turnstile that is located in the pedestrian access point 438 to be unlocked such that the pedestrian can only pass through the gate or turnstile if a PPE-complete-output-signal is generated.

In one example, the controller 435 can process the first-RFID-signalling 440 in order to make the association between any identified RFID-tag-signals 441 and the pedestrian identified as passing through the pedestrian access point 438. For instance, the controller 435 can process the signal strength of any identified RFID-tag-signals 441 over time in order to determine movement of the RFID tag 442 relative to the first RFID scanner 433. The controller can thus process the determined movement of the RFID tags 442 (based on the first-RFID-signalling 440) to identify those RFID-tag-signals 441 that are associated with the pedestrian identified as passing through the pedestrian access point 438.

For instance, the determined movement of an RFID tag 442 can indicate if the RFID tag 442 is getting closer to the first RFID scanner 433 or further away from it. The controller 435 can associate an RFID tag 442 with the pedestrian if: the RFID tag 442 is determined as getting closer to the first RFID scanner 433 within a predetermined period of time before the controller 435 detects a pedestrian; and/or the RFID tag 442 is determined as getting further away from the first RFID scanner 433 within a predetermined period of time after the controller 435 detects the pedestrian.

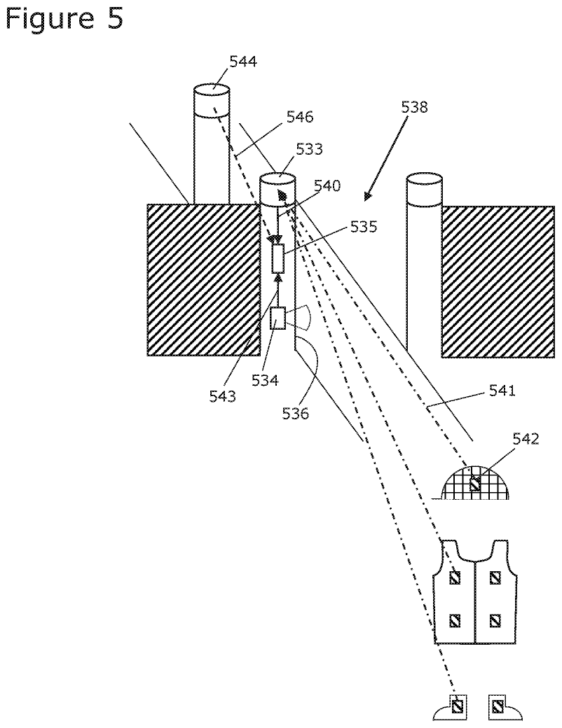

FIG. 5 shows another example of a system for monitoring pedestrians in a warehouse as they pass through a pedestrian access point 538, which is similar to the system of FIG. 4. Features of FIG. 5 that are also present in FIG. 4 are given corresponding reference numbers in the 500 series, and will not necessarily be described again here.

The system includes a first RFID scanner 533, a second RFID scanner 544, a pedestrian detector 534 and a controller 535. The first RFID scanner 533 is mounted on a first entrance/exit side of the pedestrian access point 538. The second RFID scanner 544 is mounted on a second entrance/exit side of the pedestrian access point is in the warehouse. In this way, the first RFID scanner 533 and the second RFID scanner 544 are spaced apart along a dimension that corresponds to the direction that a pedestrian can pass through the pedestrian access point 538.

The first RFID scanner 533 provides first-RFID-signalling 540 to the controller 535. The second RFID scanner 544 provides second-RFID-signalling 546 to the controller 535. The first and second RFID scanners 533, 544 can provide the respective first- and second-RFID-signalling 540, 546 to the controller 535 wirelessly or via a wired connection.

The controller 535 can then process the first-RFID-signalling 540 and the second-RFID-signalling 546 to identify any RFID-tag-signals 541 from one or more respective RFID tags 542 in the first-RFID-signalling 540 and the second-RFID-signalling 546 that are: associated with the pedestrian identified as passing through the pedestrian access point 538; and include a PPE-identifier that is associated with an item of PPE that can be worn by the pedestrian. This is similar to the processing that is described with reference to FIG. 4 except that the controller 535 processes the second-RFID-signalling 546, which is not available to the controller of FIG. 4. The controller 535 can then determine whether or not any identified RFID-tag-signals 541 in the first-RFID-signalling 540 and the second-RFID-signalling 546 represent a complete set of PPE items for the pedestrian in the same way as described above.

An advantage of the system of FIG. 5 is that the controller 535 can determine which side of the pedestrian access point 538 the RFID tag 542 is on. Therefore, by tracking the movement of the RFID tag 542 over time (as described above with reference to FIGS. 2a and 2b), the controller 535 can more accurately and reliably associate any detected RFID tags 542 with the pedestrian that is detected as passing through the pedestrian access point 538. For example, the controller 535 can only associate RFID tags 542 with the pedestrian if they are detected as moving towards the pedestrian access point pedestrian access point 538 on one side of the pedestrian access point 538 and then are detected as moving away from the pedestrian access point pedestrian access point 538 on the other side of the pedestrian access point 538. As another example, if PPE is only required on one side of the pedestrian access point 538, then the controller 535 can process the first-RFID-signalling 540 and the second-RFID-signalling 546 in order to determine which direction through the pedestrian access point 538 the pedestrian is moving. The controller 535 can then only associate the RFID-tag-signals with the pedestrian identified as passing through the pedestrian access point if they correspond to predetermined direction of travel through the pedestrian access point 538. In this way, the controller 535 can check for a complete set of PPE only when the pedestrian is entering a PPE-required region, not when they are leaving it.

As a further example, the controller 535 may only perform the step of determining whether or not any identified RFID-tag-signals in the first-RFID-signalling 540 and the second-RFID-signalling 546 represent the complete set of PPE Items for the pedestrian if the controller 535 determines that the pedestrian is passing through the pedestrian access point 538 in a predetermined direction of travel. In this way, the controller 535 can identify RFID-tag-signals 541 from RFID tags 542 passing both ways through the pedestrian access point 538, but only perform a check for a complete set of PPE for tags that are passing through one way.

As indicated above with reference to FIG. 4, the pedestrian detector 534 can be implemented as one or more RFID scanners. For instance, the first and/or the second RFID scanners 533, 544 can provide the functionality of the pedestrian detector 534 by providing RFID-signalling 540, 546 to the controller 535, and the controller 535 can process the received RFID-signalling 540, 546 to detect the presence of an RFID tag 542 that is known to be associated with a pedestrian. Optionally, this can involve one or more of the following (each of which is described in detail above): detecting an RFID tag that has a signal strength above a threshold; detecting an RFID tag for which the signal strength increases over time, such that the RFID tag is identified as moving towards the pedestrian access point 538; detecting an RFID tag for which the signal strength increases and then decreases over time, such that the RFID tag is identified as moving towards and then away from the pedestrian access point 538; if there are two RFID scanners 533, 544, then detecting an RFID tag for which: the signal strength increases over time when the RFID tag is on a first side of the pedestrian access point 538 (i.e. it is moving towards the pedestrian access point 538 from the first side); and then the signal strength decreases over time when the RFID tag is on the other side of the pedestrian access point 538 (i.e. it is moving away from the pedestrian access point 538 from the second/other first side). Furthermore, as discussed herein, if there are two RFID scanners 533, 544 then the system can determine which side of the pedestrian access point 538 the RFID tag is on using the relative signal strengths.

In some examples, one or both of the RFID scanners 533, 544 can provide the functionality of the pedestrian detector 534 only for a predetermined set of RFID tags, for example those that are known to be associated with a pedestrian's ID badge. Such RFID tags can be identified by recognising an associated badge-identifier in the received RFID-tag-signals 541. This has the advantage that the RFID scanners 533, 544 can be used as a pedestrian detector 534 even if the pedestrian is not wearing any items of PPE. It also has the advantage that additional components are not required to detect a pedestrian passing through the pedestrian access point 538.

FIG. 6 shows a further still example of a system for monitoring pedestrians in a warehouse as they pass through a pedestrian access point 638, which is similar to the system of FIGS. 4 and 5. Features of FIG. 6 that are also present in FIG. 4 or FIG. 5 are given corresponding reference numbers in the 600 series, and will not necessarily be described again here.

In this example, the pedestrian access point is a doorway 638. A first RFID scanner 633 is mounted on a first side of the doorway 638, and it has a field of view and range that is represented graphically in FIG. 6 with reference 645. The field of view of the first RFID scanner 633 is directed to the first side of the doorway 638. A second RFID scanner 644 is mounted on a second, the other, side of the doorway 638, and it has a field of view and range that is represented graphically in FIG. 6 with reference 646. The field of view of the second RFID scanner 644 is directed to the second/other side of the doorway 638,

FIG. 6 shows a pedestrian 649 approaching the doorway 638 from the first side. The pedestrian 649 is wearing a high visibility safety vest 631 that includes at least one RFID tag 642. The RFID tag 642 is within the field of view 645 of the first RFID scanner 633, and therefore it provides an RFID-tag-signal to the first RFID scanner 633 in the same way that is described above. The pedestrian 649 is carrying a box 647, which includes its own RFID tag 648. However, the RFID tag 648 that is included as part of the box 647 is not associated with an item of PPE, and it's RFID-tag-signal will not include a PPE-identifier. Therefore, the controller (not shown) of the system of FIG. 6 will not consider the RFID-tag-signals returned from the RFID tag 648 on the box 647 when determining whether or not the pedestrian 649 is wearing a complete set of PPE.

FIGS. 7a and 7b illustrate an example embodiment of a safety vest 750 (which in this example is a high visibility safety vest) for wearing in an industrial setting such as a warehouse. FIG. 7a shows a front view of the vest 750, such that a front portion of the vest 750 is visible. FIG. 7b shows a back view of the vest 750, such that a back portion of the vest 750 is visible.

As shown in FIG. 7a, a plurality of RFID tags 742a are positioned on the front portion of the vest 750. In this example there are ten RFID tags 742a on the front portion, although it will be appreciated that in other examples there may be more or fewer RFID tags 742a. At least some of the RFID tags 742a can be located on the sides of the vest 750 such that when it is being worn, these RFID tags 742a are visible to an RFID scanner that positioned to the side of the person wearing the vest 750.

As shown in FIG. 7b, a plurality of RFID tags 742b are positioned on the back portion of the vest 750. In this example there are six RFID tags 742b on the back portion, although it will be appreciated that in other examples there may be more or fewer RFID tags 742b. At least some of the RFID tags 742b can be located on the sides of the vest 750 such that when it is being worn, these RFID tags 742b are visible to an RFID scanner that is positioned to the side of the person wearing the vest 750.

Providing a plurality of RFID tags 742a, 742b on the front and the back of the vest 750 can enable the vest 750 (and more importantly, therefore, a person wearing the vest 750) to be detected by an RFID scanner for a variety of different orientations of the vest 750 relative to the RFID scanner. For example, the RFID scanner can detect the vest 750 when the person wearing the vest 750 is standing, crouching and walking to the left or right. Also, providing a plurality of RFID tags 742a, 742b on a single vest 750 can enable the vest 750 to be more reliably be detected as discussed in detail above with reference to FIGS. 2a and 2b.

Each of the RFID tags 742a, 742b in this example has an associated spacer on the inside of the RFID tag, that is between the RFID tag and a person when the safety vest is worn by the person, as will be described with reference to FIG. 7c.

FIG. 7c shows an example embodiment of an RFID tag 742 and associated spacer 751 that can be provided on the safety vest 750 of FIGS. 7a and 7b (or any other garment disclosed herein). The spacer 751 is positioned between the RFID tag 742 and the human body when the vest 750 is being worn. Use of such a spacer 751 can increase the range at which the RFID tag 742 can be detected for an RFID scanner of a given transmitted power. This is because the fluid in the human body absorbs the RF energy that is emitted from the RFID scanner, and therefore spacing the RFID 742 apart from the human body can reduce the negative impact of the RF energy being absorbed by the human body.

The spacer 751 can be at least 12 mm thick, and in some applications at least 16 mm thick. These thicknesses have been found to provide a good improvement in the detectability of the RFID tag 742 without making the vest 750 too bulky and cumbersome.

The spacer 751 may comprise a foam material. Foam has a high dielectric constant and will absorb less RF energy than the human body. Foam is also advantageously lightweight.

Each of the RFID tags 742a, 742b includes an identifier that it provides as part of an RFID-tag-signal when it is excited by an RFID scanner. Such an identifier can also be referred to as an electronic product code (EPC). In this example, the identifier for each RFID tag 742 is unique and has the following format:

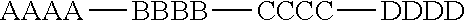

### Where:

AAAA is a product-type-identifier, which is indicative of the type of safety vest with which the RFID tag 742 is associated;
BBBB is a product-provider-identifier, which is indicative of a provider of the safety vest 750 or more generally a pedestrian monitoring system with which the vest 750 is associated;
CCCC is a vest-identifier, which is a unique identifier of the vest 750 with which the RFID tag 742 is associated. For instance, the vest-identifier can be implemented as a serial-number. In one example, the vest-identifier may be unique for a given product-type-identifier but can be reused for different product-type-identifiers. In this way, each combination of product-type-identifier and vest-identifier is unique. Such a vest-identifier is one example of a garment-identifier that is discussed above;
DDDD is a unique-tag-identifier, which is a unique identifier for each RFID tag 742 on any given safety vest. The unique-tag-identifier can be considered as a vest-position-identifier, which is indicative of a position on the vest 750 at which the respective RFID tag 542 is attached. For instance, an association between unique-tag-identifiers and the locations of the associated RFID tags on the vest can be stored in computer memory such that a controller can look up the position of the RFID 742 on the vest 750 based on a received unique-tag-identifier.

In the above disclosed pedestrian monitoring system examples of FIGS. 2 to 6, the pedestrian monitoring system may preferentially scan for RFID tags associated with pedestrians, such as garment RFID tags 742 or badge RFID tags, at a higher repetition rate than a scan rate for other RFID tags (such as those on fixed infrastructure or stock etc). For example, the repetition rate for the pedestrian RFID tags may be 2×, 3×, 5×, 10× or higher than the repetition rate for other RFID tags. The pedestrian monitoring system may output a signal that only excites tags of a particular type and/or having a particular identifier associated with pedestrian RFID tags. Such an RFID tag can have a microcontroller and memory etc, and can be powered using the electromagnetic energy of the incoming RF wave from the reader. The RFID tag can have sufficient processing power for it to be able to determine whether or not it should respond to an Incoming request based on it's identifier. Alternatively, or additionally, the controller may process RFID signalling with an identifier associated with a pedestrian RFID tag at a first processing rate and process RFID signal with any identifier at a second processing rate, less than the first processing rate. In this way, pedestrian tags may be scanned and/or detected more frequently which can provide faster detection of pedestrians, which is particularly advantageous for the vehicle scanning embodiments.

In the above disclosed pedestrian monitoring system examples of FIGS. 2 to 6, the controller can identify particular pedestrians based on RFID tags associated with an ID badge worn by the pedestrian. In particular, the RFID signalling from the RFID tag in the badge may include an associated badge-identifier. In some examples, the controller may associate identifiers for RFID tags 742 for PPE garments with a particular badge-identifier when the corresponding RFID signalling is received together. The controller may log the association of the identifier(s) of the PPE garment(s) to the ID badge (and pedestrian) to a central server accessible by other controllers of the pedestrian monitoring system (on other FLTs/vehicles or access points). In some examples, the pedestrian monitoring system may register the PPE garment identifier(s) with the bade-identifier after a threshold number of associations have been logged (for example one or two or three). In this way, controllers of the system may detect the presence of a particular pedestrian via detection of only a single garment identifier. If later, the controller detects a different badge identifier (of a different pedestrian) with the same garment identifier(s), the controller may de-register the badge identifier of the previous pedestrian and/or register the badge identifier of the new pedestrian with the garment identifier(s).

Examples disclosed herein can also include an algorithm that associates safety vests or other PPE with specific people. For instance, all pedestrians may be required to wear an ID badge with a single RFID tag (with an associated badge-identifier, as discussed above). Since the ID badge has only a single RFID tag, it is quite possible that an RFID scanner (such as the ones that are associated with a fork lift truck in FIGS. 2a-2c) will miss the RFID-tag-signal from the RFID tag associated with the ID badge. This may especially be the case if the RFID scanner excites one or more vest RFID tags at the same time and receives multiple RFID-tag-signals back from those RFID tags. However, due to the respective number of RFID tags, it is unlikely that the RFID scanner will miss RFID-tag-signals from vest RFID tags (or other PPE RFID tags) if it is able to detect an RFID-tag-signal from a single RFID tag on an ID badge. Therefore, if an RFID-tag-signal from an ID badge RFID tag is detected, but no RFID-tag-signals from vest RFID tags (or other PPE RFID tags) are detected, then the controller can identify this as an instance of a pedestrian not wearing a complete set of personal protective equipment (PPE) and it can take any of the remedial actions that are described herein.

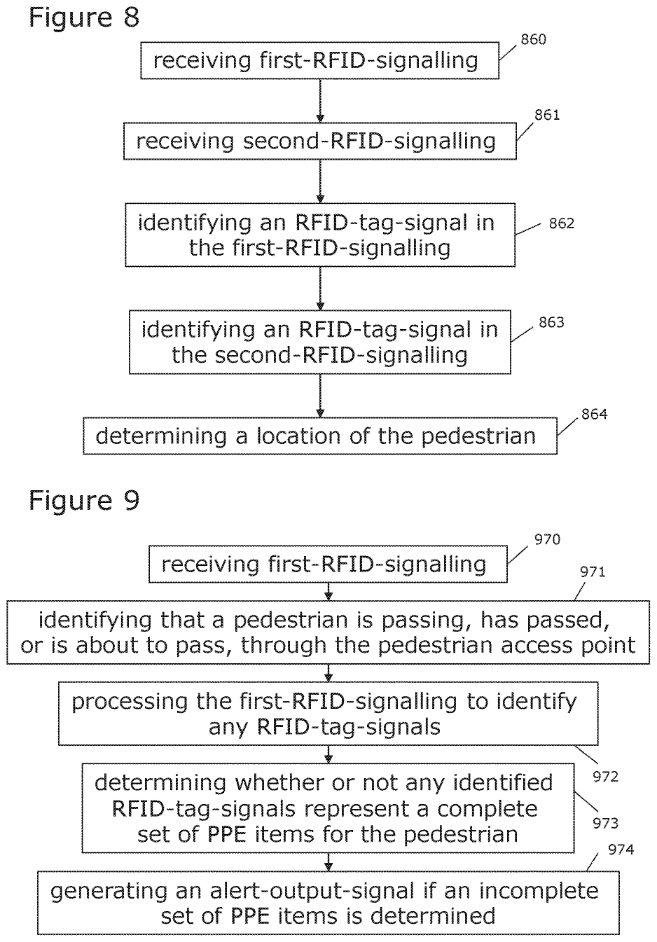

FIG. 8 illustrates an example embodiment of a method of monitoring pedestrians in a warehouse. The method includes, at step 860, receiving first-RFID-signalling from a first RFID antenna mounted on a vehicle. At step 861, the method includes receiving second-RFID-signalling from a second RFID antenna mounted on the vehicle. As discussed above, a field of view of the first RFID antenna is spaced apart from a field of view of the second RFID antenna in a first dimension. At step 862, the method includes identifying an RFID-tag-signal from an RFID tag that is associated with a pedestrian in the first-RFID-signalling. At step 863, the method includes identifying an RFID-tag-signal from the RFID tag that is associated with the pedestrian in the second-RFID-signalling. Then, at step 864, the method includes determining a location of the pedestrian with reference to the vehicle based on the RFID-tag-signals in both the first-RFID-signalling and the second-RFID-signalling.

FIG. 9 illustrates an example embodiment of a method of monitoring pedestrians in a warehouse. The method includes, at step 971, receiving first-RFID-signalling from a first RFID antenna associated with a pedestrian access point in a warehouse. At step 972, the method includes identifying that a pedestrian is passing, has passed, or is about to pass, through the pedestrian access point, and in response: at step 973, processing the first-RFID-signalling to identify any RFID-tag-signals from one or more respective RFID tags that: are associated with the pedestrian identified as passing through the pedestrian access point; and include a PPE-identifier that is associated with an item of PPE that can be worn by the pedestrian; at step 973, determining whether or not any identified RFID-tag-signals represent a complete set of PPE items for the pedestrian; and at step 974, generating an alert-output-signal if an incomplete set of PPE items is determined.

1. A controller for monitoring pedestrians in a warehouse, wherein the controller is configured to:
receive first-RFID-signalling from a first RFID antenna mounted on a vehicle;
receive second-RFID-signalling from a second RFID antenna mounted on the vehicle, wherein a field of view of the first RFID antenna is spaced apart from a field of view of the second RFID antenna in a first dimension;
identify an RFID-tag-signal from an RFID tag that is associated with a pedestrian in the first-RFID-signalling;
identify an RFID-tag-signal from the RFID tag that is associated with the pedestrian in the second-RFID-signalling; and
determine a location of the pedestrian with reference to the vehicle based on the RFID-tag-signals in both the first-RFID-signalling and the second-RFID-signalling.

2. The controller of claim 1, further configured to:
provide an output-signal based on the determined location of the pedestrian.

3. The controller of claim 1, further configured to:
compare a signal strength of the RFID-tag-signal in the first-RFID-signalling with a signal strength of the RFID-tag-signal in the second-RFID-signalling in order to determine the location of the pedestrian with respect to the vehicle in the first dimension.

4. The controller of claim 1, further configured to:
identify a plurality of RFID-tag-signals from the RFID tag in the first-RFID-signalling over a period of time;
identify a plurality of RFID-tag-signals from the RFID tag in the second-RFID-signalling over the period of time;
determine a movement of the pedestrian with reference to the vehicle based on the plurality of RFID-tag-signals in both the first-RFID-signalling and the second-RFID-signalling; and
provide an output-signal based on the determined movement of the pedestrian.

5. The controller of claim 4, further configured to:
provide an output-signal based on: the determined movement of the pedestrian; and the determined location of the pedestrian.

6. The controller of claim 1, further configured to:
identify a plurality of RFID-tag-signals from a respective plurality of RFID tags that are associated with a pedestrian in the first-RFID-signalling;
identify a plurality of RFID-tag-signals from the respective plurality of RFID tags that are associated with the pedestrian in the second-RFID-signalling; and
determine the location of the pedestrian with reference to the vehicle based on the plurality of RFID-tag-signals in both the first-RFID-signalling and the second-RFID-signalling.

7. The controller of claim 6, further configured to:
determine the location of the pedestrian with reference to the vehicle based on the plurality of RFID-tag-signals in both the first-RFID-signalling and the second-RFID-signalling only if at least a threshold number of RFID-tag-signals from respective RFID tags are identified in both the first-RFID-signalling and the second-RFID-signalling.

8. The controller of claim 6, wherein each of the plurality of RFID-tag-signals includes:
a garment-identifier that is associated with a garment that can be worn by the pedestrian.

9. The controller of claim 8, wherein each of the plurality of RFID-tag-signals further includes:
a garment-position-identifier that is indicative of a position on the garment at which the respective RFID tag is attached.

10. The controller of claim 9, further configured to:
identify a plurality of RFID-tag-signals from a respective plurality of RFID tags in each of the first-RFID-signalling and the second-RFID-signalling that have the same garment-identifier;
process the garment-position-identifier in each of the identified plurality of RFID-tag-signals to determine an orientation of the pedestrian that is wearing the garment with respect to the vehicle; and
provide an output-signal based on the determined orientation of the pedestrian.

11. The controller of claim 1, further configured to:
identify the RFID-tag-signal in each of the first-RFID-signalling and the second-RFID-signalling only if the RFID-tag-signal has a signal strength that is greater than a threshold value.

12. The controller of claim 1, further configured to:
identify the RFID-tag-signal in each of the first-RFID-signalling and the second-RFID-signalling only if the RFID-signalling includes at least a threshold number of RFID-tag-signals from the RFID tag over a predetermined period of time.

13. The controller of claim 1, further configured to:
receive a vehicle-speed-signal that represents the speed of the vehicle;
provide an output-signal based on: the determined location of the pedestrian; and the vehicle-speed-signal.

14. The controller of claim 1, further configured to:
receive third-RFID-signalling from a third RFID antenna mounted on the vehicle, wherein a field of view of the third RFID antenna is offset from the field of view of at least one of the first RFID antenna and the second RFID antenna in a second dimension that is transverse to the first dimension;
receive fourth-RFID-signalling from a fourth RFID antenna mounted on the vehicle, wherein a field of view of the fourth RFID antenna is offset from the field of view of at least one of the first RFID antenna and the second RFID antenna in the second dimension;
identify an RFID-tag-signal from the RFID tag that is associated with the pedestrian in the third-RFID-signalling;
identify an RFID-tag-signal from the RFID tag that is associated with the pedestrian in the fourth-RFID-signalling; and
determine a location of the pedestrian with reference to the vehicle based on the RFID-tag-signals in each of the first-RFID-signalling, the second-RFID-signalling, third-RFID-signalling and the fourth-RFID-signalling.

15. (canceled)

16. (canceled)

17. A method of monitoring pedestrians in a warehouse, wherein the method comprises:
receiving first-RFID-signalling from a first RFID antenna mounted on a vehicle;
receiving second-RFID-signalling from a second RFID antenna mounted on the vehicle, wherein a field of view of the first RFID antenna is spaced apart from a field of view of the second RFID antenna in a first dimension;
identifying an RFID-tag-signal from an RFID tag that is associated with a pedestrian in the first-RFID-signalling;
identifying an RFID-tag-signal from the RFID tag that is associated with the pedestrian in the second-RFID-signalling; and
determining a location of the pedestrian with reference to the vehicle based on the RFID-tag-signals in both the first-RFID-signalling and the second-RFID-signalling.

18. A controller for monitoring pedestrians in a warehouse, wherein the controller is configured to:
receive first-RFID-signalling from a first RFID antenna associated with a pedestrian access point in a warehouse;
identify that a pedestrian is passing, has passed, or is about to pass, through the pedestrian access point, and in response:
process the first-RFID-signalling to identify any RFID-tag-signals from one or more respective RFID tags that: are associated with the pedestrian identified as passing through the pedestrian access point; and include a PPE-identifier that is associated with an item of PPE that can be worn by the pedestrian;
determine whether or not any identified RFID-tag-signals represent a complete set of PPE items for the pedestrian; and
generate an alert-output-signal if an incomplete set of PPE items is determined.

19. The controller of claim 18, further configured to:
process a signal strength of any identified RFID-tag-signals over time in order to determine movement of the associated RFID tags relative to the first RFID antenna; and
process the determined movement of any RFID tags to identify any RFID-tag-signals that are associated with the pedestrian identified as passing through the pedestrian access point.

20. The controller of claim 18, further configured to:
compare the items of PPE that are associated with the identified RFID-tag-signals with a list of items of PPE that are required.

21. The controller of claim 18, wherein the alert-output-signal includes details of the item or items of PPE that have not been detected.

22. The controller of claim 18, wherein:
the first RFID antenna has a field of view associated with a first entrance/exit side of the pedestrian access point in the warehouse;
wherein the controller is further configured to:
receive second-RFID-signalling from a second RFID antenna that has a field of view associated with a second entrance/exit side of the pedestrian access point;
process the first-RFID-signalling and the second-RFID-signalling to identify any RFID-tag-signals from one or more respective RFID tags in the first-RFID-signalling and the second-RFID-signalling that are: associated with the pedestrian identified as passing through the pedestrian access point; and include a PPE-identifier that is associated with an item of PPE that can be worn by the pedestrian; and
determine whether or not any identified RFID-tag-signals in the first-RFID-signalling and the second-RFID-signalling represent the complete set of PPE items for the pedestrian.

23. (canceled)

24. (canceled)

25. (canceled)

26. (canceled)

27. (canceled)

28. (canceled)
